(19) United States
(12) Patent Application Publication
(10) Pub. No.: US 2009/0087828 A1
(43) Pub. Date: Apr. 2, 2009

(54) SYSTEM, METHOD, AND TOOL FOR COMPUTER-BASED LEARNING

(76) Inventors: Laura Hartman, Chicago, IL (US); Jerry Smith, Chicago, IL (US); Tony Grossman, Chicago, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/243,272

(22) Filed: Oct. 1, 2008

Related U.S. Application Data
(60) Provisional application No. 60/960,494, filed on Oct. 1, 2007.

(51) Int. Cl. G09B 7/00

(52) U.S. Cl. 434/362

(57) ABSTRACT

Systems and methods of providing remote, real-time computer-facilitated instruction, interaction, testing, and assessment to a plurality of users or participants. The system includes a system (e.g., a server) for shaping and directing a learning or decision-making environment. The shaping/directing system selectively provides content to users based on responses from the users to create a user-directed and generated learning or decision-making experience. The users connect to the shaping/directing system through a plurality of respective, user-controlled client devices. Each respective client device includes an input device (e.g., a pointing device) and an output device (e.g., a display). The output device communicates portions of the content, including decision points, to the respective user. The input device receives responses from the respective user. The responses reply to the respective decision points.

### CROSS-REFERENCE TO RELATED APPLICATION

This application claims the benefit of U.S. Provisional Patent Application No. 60/960,494, filed Oct. 1, 2007, the entire contents of which are hereby incorporated by reference.

### FIELD OF THE INVENTION

Embodiments of the invention relate to systems, methods, and tools for computer-based learning. More specifically, embodiments of the invention are directed to systems, methods, and tools for online access to remote, real-time, computer-facilitated learning.

### BACKGROUND

Often universities and corporations educate groups of people in fields and curricula that can be best learned through examples, case studies, and group interaction. These fields, such as ethics, leadership, and decision-making, are frequently taught in groups using pre-written scenarios (“case studies”). In addition, in order to assess the learning that takes place during the exercise, surveys of participants are often used to determine the participants' knowledge, skills, and beliefs.

In the past, case studies have been distributed in class or in advance, read aloud, or otherwise presented to groups of participants (such as students); and then the facilitator (such as an instructor) manually performs a survey of those in attendance in order to obtain feedback related to the scenarios. In order to create a more effective process, to individualize it, and to automate it, computers have been used to provide case studies and to assess participants. However, the use of computers can create other problems because participants often work and learn at different paces and some participants may complete cases before others, which may eliminate vital group discussion and work. Moreover, simply broadcasting video lectures, such as on television or over the internet, creates other drawbacks, such as a lack of integrated, active, real-time participant feedback, and trainers' assessment of participants. In addition, it allows participants to passively watch rather than interacting with a group in order to learn more effectively and to make more accountable decisions.

Also, different participants have different levels of understanding and knowledge. For instance, in a large group of participants, a vast majority of participants may be aware and knowledgeable of a certain area of study. However, a small, but significant portion of the group may be completely unknowledgeable of that same area of study. Without individualized training, the entire group must endure training in an area with which most participants are familiar, in order to teach a small group. On the other hand, in an entirely individualized training, participants with foreknowledge of a certain area may work ahead of others and eliminate the possibility for group learning, teaching, and discussion.

Finally, faculty need additional ways in which to assess the skills and learning of participants, as well as the effectiveness of their training. In order to make that process as quick, easy, and accurate as possible, computers are often used to assess participant knowledge and awareness of the presented program. By analyzing these assessments, faculty may be able to assess both participant learning and training effectiveness. Faculty can then adjust the program or presentation appropriately. However, assessment is an emerging discipline in some areas and may sometimes be inconvenient to classroom instruction and training.

### SUMMARY

What is needed, then, is a facilitated, real-time, interactive training system that utilizes individualized learning where appropriate, but which retains the vital aspects of group learning, while helping leaders (e.g., faculty) to better assess participant learning and training effectiveness on an ongoing basis.

In one embodiment, the invention uses a computer-facilitated case study in order to teach groups of participants by encouraging group interaction. As group interaction can be an important aspect of the learning the process, the invention ensures that the group works together and discusses the problem and the training in front of them.

In another embodiment, the invention uses a computer system to assess the participants' knowledge and skill of a subject matter before participating in the case study; uses the computer system and a network, such as the internet, to allow participants to view remotely a series of scenarios and narratives; and asks questions of the individual participants and requires groups of the participants to work together, in real-time, to interact and to discuss the material after answering the questions. Multiple scenarios and lectures may be provided to a group of participants and, depending upon the choices of the group of participants, different scenarios or lectures may be provided in a decision-tree framework. Thus, the invention, in one implementation, not only allows both individual and group instruction in the same subject area, but it also allows for automated and nearly instantaneous tailoring of course material to each group of participants based upon that group's particular decision tree. Choices along the decision tree are made by the computer based on either a majority rule format or computer default choice where there is not majority. By assessing the participants' knowledge and skills in the subject matter after the course, the system may automatically assess participant learning.

In another embodiment, the invention provides a method of providing a computer-directed learning environment to a plurality of users. Each user controls a respective client device remote from a server. The method is performed by the server. The method includes retaining instructions at the server, retaining content at the server, and interactively communicating with the client devices. The instructions are executable by the client devices to promote a computer-facilitated learning environment. The content is utilized by the client devices to provide an exercise in the learning environment. In one implementation, the server sends at least a first portion of the instructions to the first client device, sends a first portion of the content to the first client device, receives a first response from the first client device, and sends a second portion of the content to the first client device. The first portion of the content can have a first decision point in the exercise, the first response can respond to the first decision point and include a first decision from the first user, and the second portion of the content can be responsive to the first decision. The server can also promote interaction among the plurality of users after sending the first portion of the content, but before sending the second portion of the content.

In another embodiment, the invention provides a method of receiving computer-directed content at a user-controlled client device from a server. The method is performed by the user-controlled client device. The method includes receiving instructions from the server and receiving first content from the server. The instructions construct a portion of a computer-facilitated learning environment, and the first content including a first decision point of an exercise. The method further includes sending a first response to the server, the first response responding to the first decision point and including a first decision from a user; and receiving second content from the server, the second content being responsive to the first decision; and sending and receiving a first message and a second message, respectively, with the server after the sending the first portion of the content and before the sending the second portion of the content.

In another embodiment, the invention provides a system for providing remote, real-time computer-facilitated instruction, interaction, and testing to a plurality of users. The system includes a system for shaping and directing a learning environment and a plurality of user-controlled client devices connected to the shaping/directing system. The shaping/directing system includes a server application to provide content of an exercise based on responses from the users and can allow communication among the users. The shaping/directing system further includes a database to maintain the content. The plurality of user-controlled client devices provides the learning environment to the respective users, and sends the responses to the shaping/directing system. Each client device includes an input device and an output device. The output device communicates portions of the content to the respective user. The portions include decision points in the exercise. The input device receives responses from the respective user replying to the respective decision points.

Other aspects of the invention will become apparent by consideration of the detailed description and accompanying drawings.

### BRIEF DESCRIPTION OF THE DRAWINGS

FIG. 1 is a block diagram representing an exemplary system incorporating the invention.

FIG. 2 is a block diagram representing a system for providing an instruction, interaction, testing environment.

FIG. 3 is a flow chart representing a user utilizing a web site provided by the system of FIG. 2.

FIG. 4 is a screen print of a base web page of the web site.

FIG. 5 is a screen print of a login web page of the web site.

FIG. 6 is a screen print of a lobby web page of the web site.

FIG. 7 is a screen print of an introduction web page of the web site.

FIG. 8 is a screen print of a first web page of a survey provided by the web site.

FIG. 9 is a screen print of a web page of the web site, where the web page provides a definition.

FIG. 10 is a screen print of a web page of the web site, where the web page provides a question to the user.

FIG. 11 is a screen print of a result web page of the web site.

FIG. 12 is a screen print of a web page of the web site, where the web page includes a decision point.

FIG. 13 is a screen print of a web page of the web site, where the web page allows a user to enter a detailed answer to a question.

FIG. 14 is a screen print of a web page of the web site, where the web page allows the user to view answers of the other participants.

FIG. 15 is a flow chart representing the flow of asking and receiving answers for a question.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The use of “including,” “comprising,” or “having,” and variations thereof herein is meant to encompass the items listed thereafter and equivalents thereof as well as additional items. The use of “mounted,” “connected,” “supported,” and “coupled” and variations thereof herein encompass both direct and indirect mountings, connections, supports, and couplings. Further, “connected” and “coupled” are not restricted to physical or mechanical connections or couplings.

As should also be apparent to one of ordinary skill in the art, the systems shown in the figures are models of what actual systems might be like. As noted, many of the modules and logical structures described are capable of being implemented in software executed by a microprocessor or a similar device or of being implemented in hardware using a variety of components including, for example, application specific integrated circuits (“ASICs”). Terms like “processor,” “module,” and “tool” may include or refer to both hardware and/or software. In addition, capitalized terms and acronyms are used. Such terms are used to conform to common practices and to help correlate the description with the examples described and the drawings. However, no specific meaning is implied or should be inferred simply due to the use of capitalization.

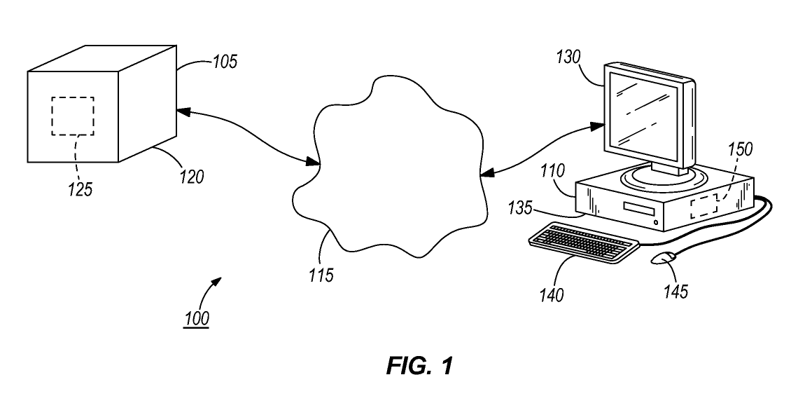

FIG. 1 illustrates a system 100 for promoting remote, real-time computer-facilitated instruction, interaction, testing, and reporting. The system 100 includes a system 105 for providing an instruction, interaction, testing, and reporting environment; and a remote device 110. An exemplary system 105 can be provided by an application service provider (“ASP”) server and the remote device can be a client computer. In one construction, the remote device 110 connects to the system 105 over one or more networks 115, such as a local area network (“LAN”), a wide area network (“WAN”), a cellular network, the Internet, etc. In another construction, the remote device 110 directly connects to the system 105. It should be understood that the remote device 110 can be one of or include various devices, such as a personal computer, a personal digital assistant (“PDAs”), a Blackberry device, a cellular phone, or another type of device configured to exchange data with system 105. In some implementations, the remote device 110 executes a browser application to request, access, view, and provide screens (e.g., web pages) originating from the system 105.

In one construction, the system 105 is a server that includes a housing 120 containing components such as one or more processors, random access memory, read only memory, storage devices (e.g., hard drives, CD-ROM disk drives, etc.), and the like. The random access memory, read only memory, storage devices, and related memory devices are collectively referred to herein as memory 125. The system 105 executes instructions to construct the environment.

The remote device 110, in one construction, is a computer that includes components such as a housing 135, input device (keyboard 140, mouse 145, microphone, etc.) and output device (monitor 130, speaker, etc.) It should be apparent to those skilled in the art that the hardware housing 135 may contain components such as one or more processors, random access memory, read only memory, storage devices (e.g., hard drives, CD-ROM disk drives, etc.), and the like. The random access memory, read only memory, storage devices, and related memory devices are collectively referred to herein as memory 150. The remote device receives and executes instructions stored at the device 110 and received from the system 105 to convey the instruction, interaction, testing, and reporting environment (hereinafter, simply referred to as the “learning environment”) to the user. An exemplary learning environment conveyed to the user is in the form of a web site, which is discussed further below.

Before proceeding further, it should be understood that the system 105 may comprise multiple devices (e.g., multiple servers) and the remote device 110 may be one of a plurality of devices (e.g., multiple computers). The multiple remote devices 110 allow a group of users (or participants) to participate in an exercise provided by the system 105. The network 115 may comprise multiple networks. For example, the network 115 may include a first network directly coupled to the system 105, the Internet, and a second network directly coupled to the remote device 120).

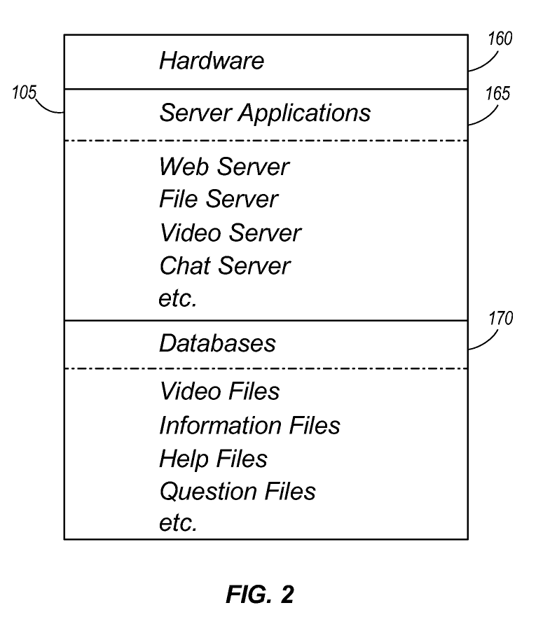

The system 105 stores instructions to construct the learning environment, such as an education environment or a decision environment, both of which are discussed below. The learning environment is computer shaped and directed based on information from a leader, such as an educator or a decision maker. In one construction (FIG. 2), the system 105 includes conventional hardware 160 (processors, memory 125, interfaces, etc.), server applications 165 (e.g., web servers, file servers, proxy servers, mail servers, video servers, chat servers, etc.) to provide a web site based learning environment, and databases 170 maintaining content (e.g., video files, information files, help files, question files, etc.).

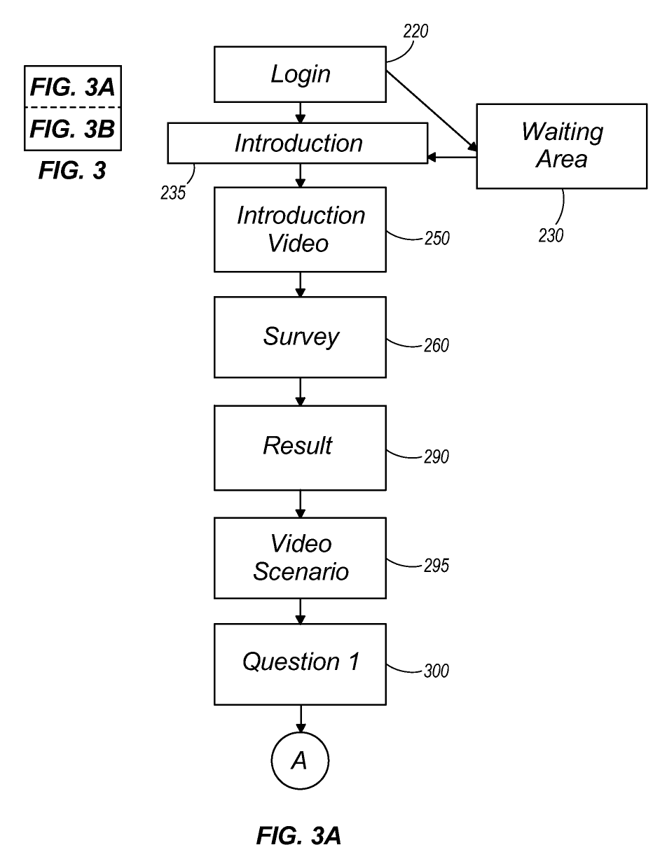

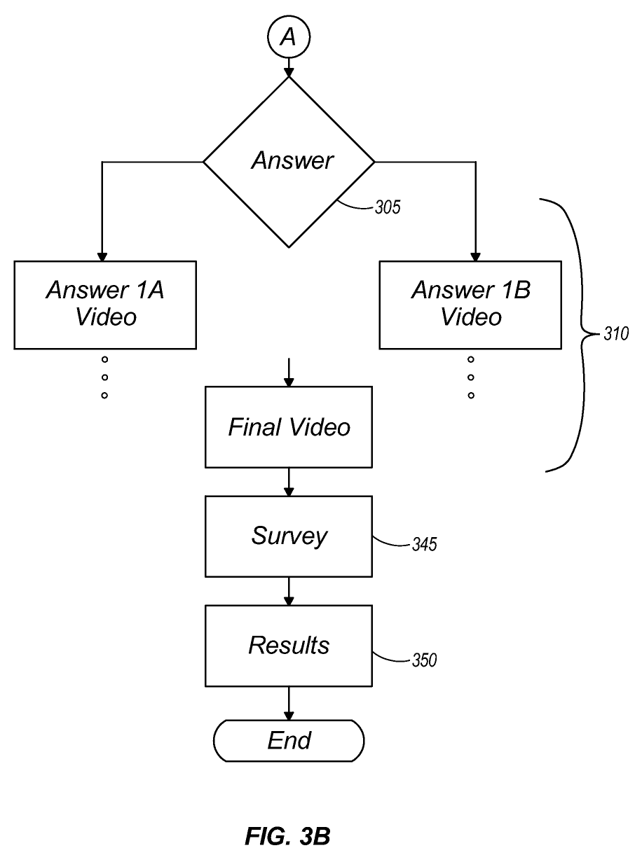

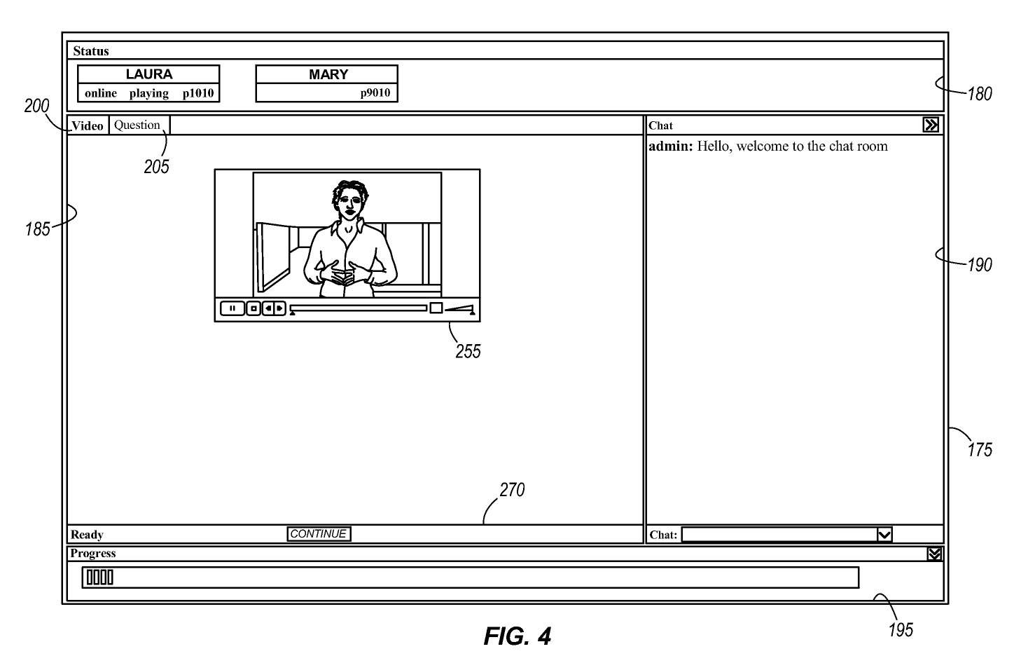

Referring now to FIGS. 3-15, FIGS. 3 and 15 represent an exemplary flow for a user/participant (e.g., a student) or group of users/participants (e.g., a class) utilizing the computer-shaped and -directed learning environment. FIGS. 4-14 provide screen prints of an example web site conveying the computer-based learning environment.

Before discussing one exemplary flow of the web site, a base web page 175 (FIG. 4) will first be discussed. The base web page 175 includes a status pane 180 having the present participants of the pending lesson, a content pane 185 having a plurality of tabs, a chat pane 190, and a progress pane 195. In FIG. 4, the plurality of tabs includes a video tab 200 and a question tab 205. Controlling the video tab 200 results in the content pane 185 becoming a video pane, which provides video-related content. Controlling the question tab 205 results in the content pane 185 becoming a question pane, which provides question-related content. As should be apparent, when a tab is activated, the content pane 185 takes the form of the related content for the activated tab.

The video and question tabs 200 and 205 are exemplary content tabs and other tabs can be provided. Other content tabs and content panes allow the user to access other content and resources necessary to progress through the exercise. Examples of other resources may be, but are not limited to, background information about the exercise presented, external web links, or current or previous notes the user may have taken. Additional materials may be pre-loaded into the system 105. When the exercise is not used for education, but instead is used for the purpose of group decision-making (such as a conference, board meeting, or other group “gatherings), the content resources can be accessed and referenced prior to or during the decision-making experiences. Another content tab typically available to the user is a help tab. The help tab allows the user to access help screens that explain how the user interacts with the web site and other information the user may need to properly navigate the web site.

In some implementations, navigation under control of the user or access to particular tabs is localized to the particular user that presses the appropriate button. However, other participants in the training may be able to view the location or activity of each of the participants participating in their group during the exercise. In this way, the participants can see when each of the other participants is ready to proceed to the next stage of the exercise.

As already stated, the base web page 175 is an exemplary web page. Other web pages provided by the system 105 can include other panes, do not require all of the disclosed panes, and can be constructed differently from the base web page 175 discussed herein.

In the web page 175 of FIG. 4, participants are presented with video scenarios in the video pane, while communicating with the other members of the group through the chat pane 190. Where a group decision is necessary, participants may vote or decide with the question pane. The status pane 180 informs the participant how many other participants are participating in the training. The status pane 180 may also provide information about the other participants. For example, when a decision is necessary, the status pane 180 may let the user determine when the other participants have voted. The progress pane 195 provides the status or progress of the pending lesson or other similar information.

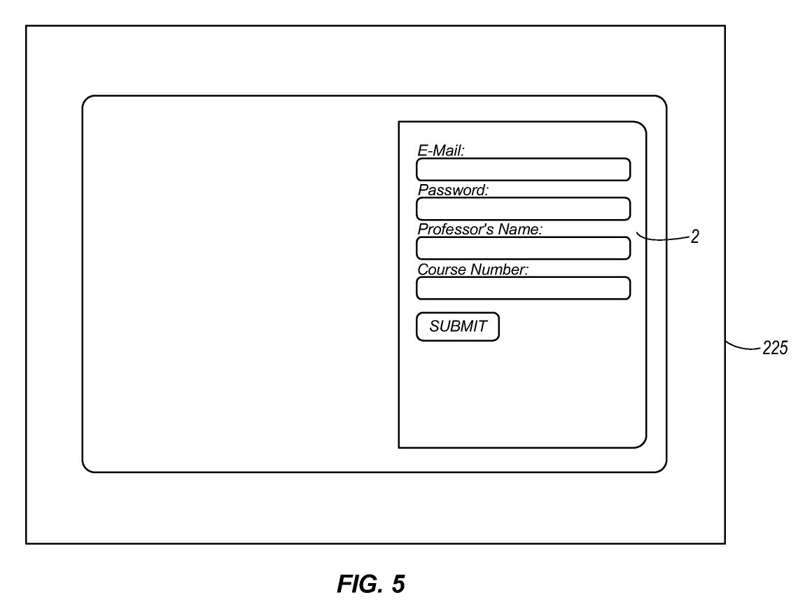

Referring back to FIG. 3, a participant accesses the web site and provides login/authentication information (block 220). An exemplary login web page 225 is shown in FIG. 5. As can be seen in this figure, the learning environment may be used in academic or commercial settings. More specifically, the environment can be used for courses and workshops, such as case studies, scenarios, surveys, group discussions, and group decisions.

For login page 225, the user may login using an e-mail address or other unique identifier and a private password. In some environments, such as colleges, universities, corporations, or other organizations, participants may be required to attend multiple courses, workshops, presentations, or training sessions. In these settings, participants may enter information identifying the proper course, instructor, or other identifying information. As used herein, the term participant includes any student, trainee, decision-maker, or other participant using the system 1 00. Also, as used herein, the term leader includes any teacher, professor, instructor, or facilitator leading the exercise. Finally, it should be noted that, though FIGS. 4-14 may be described using a case study, other embodiments are envisioned where the invention offers instruction through other means, such as video lectures, or where the invention is used to facilitate remote and distributed decision making.

When the system 100 is used to facilitate remote and distributed decision making, such as during a board meeting or remote conferencing scenario, the decisions to be made can be pre-loaded into the program, analogous to the academic or training environment, with a decision tree (discussed below) established in advance. The decision tree is based on the potential decisions the participants can make. When an issue is resolved based on questions asked or resources provided, the next question is presented, which can be based on the previously created structure, and resources are then made available to participants via the content pane 185 (FIG. 4). The participants can also use the chat pane 190 to discuss the possible options, review the materials and resources of the content pane 185, view the question to be answered in the question pane, and respond. When all have responded (as maybe shown with the status pane 180), the next decision is presented until all issues have been resolved.

In one implementation of the system 100, the leader has the ability to monitor and track the progress and success of participants as they use the system 105. By having participants log in using unique identifiers and passwords, the system 105 can accurately identify and track all participants' progress.

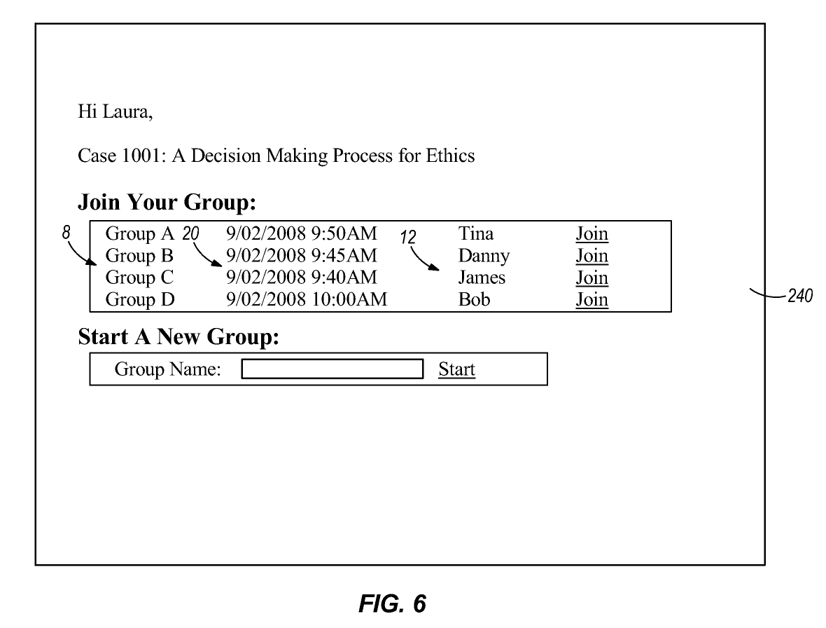

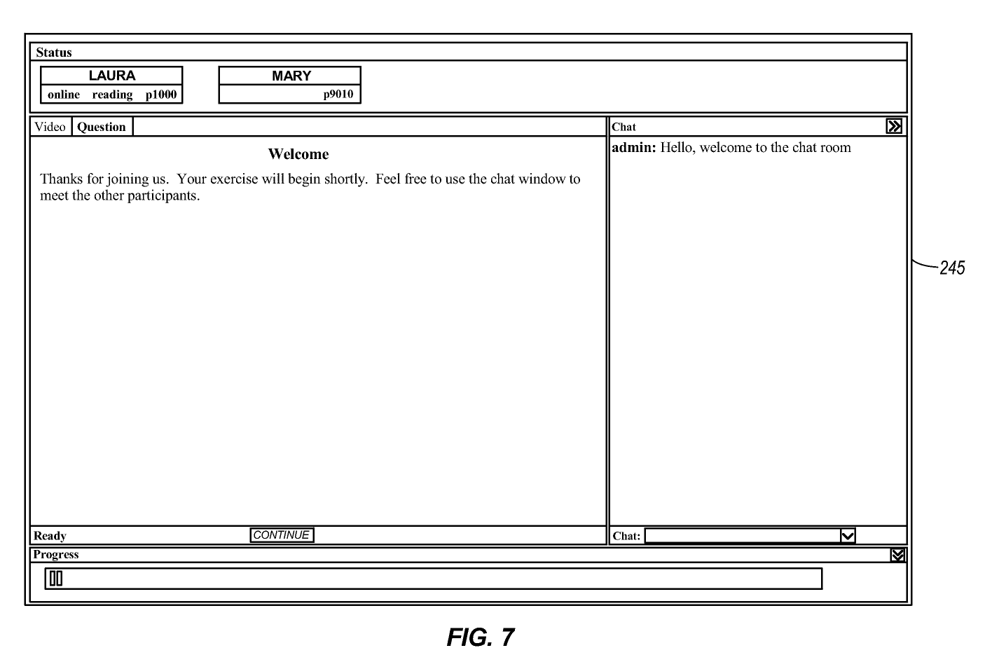

Referring back to FIG. 3, after logging in, the user may go to a lobby/waiting area web page (block 230) or proceed to an introduction web page (block 235). FIG. 6 provides the lobby web page 240. After logging in, the user waits at the lobby web page 240 until the other participants who will participate in the exercise join the particular exercise. Once all participants are present, the group proceeds to an introduction web page 245 (FIG. 7). When the user is the only participant for the exercise, the user may proceed directly to the introduction web page 245.

In the shown flow of FIG. 3, the user (and group) proceeds to an introduction video (block 250). FIG. 4 depicts the video pane with a video introduction. This prerecorded video may explain the web site, as well as explain the exercise the user is about to undertake. As depicted in FIG. 4, where appropriate, the user has control over the presented video. Controls 255 allow an individual to momentarily go back, pause, or continue forward. However, in order to ensure that participants proceed at the same pace, internal timers may prevent individual participants from pausing a video for too long or rewinding a video too far back. Additionally, when group work or discussions are necessary, the system 105 may prevent a participant from having any control.

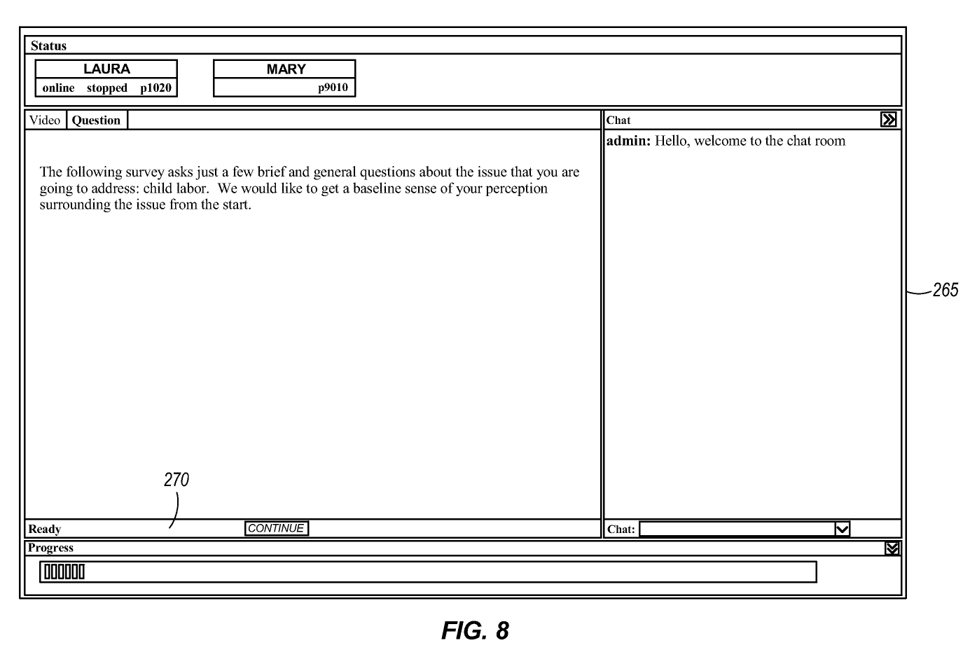

After the video, the participants may perform an introductory skill assessment (block 260; FIG. 3). FIG. 8 shows a first web page 265 of the survey. In this portion of the web site, the user, along with the other participants, are surveyed to determine their knowledge and perceptions of certain issues before participating further in the exercise. This preliminary assessment can later be used as a benchmark in order to determine how much the participants have learned. In web page 265, a control bar 270 is shown as being limited to a “Ready” option. This illustrates how the control bar may be limited to certain operations on some pages.

In some implementations, the web site can also be used to grade participants. A skill assessment may be used as a component for grading the participants. However, other criteria, as defined by the leader, may also be used.

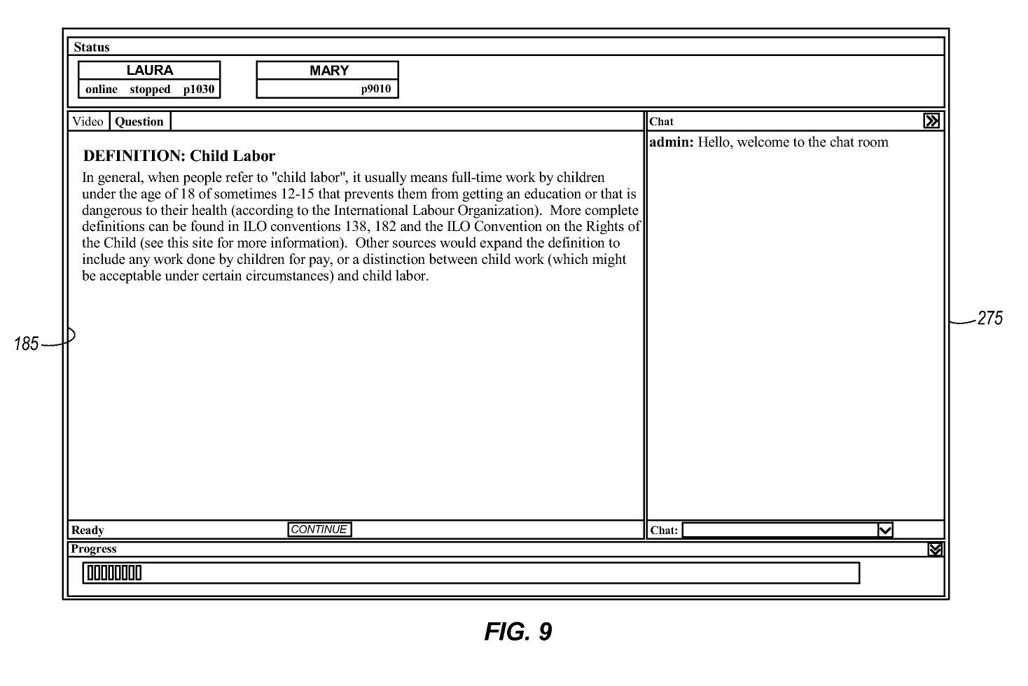

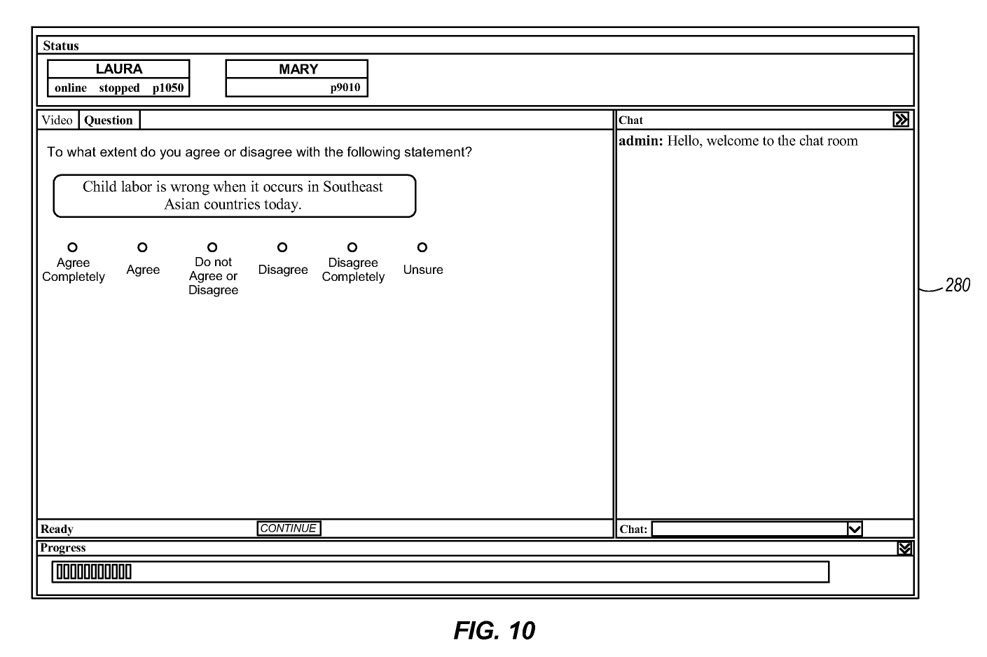

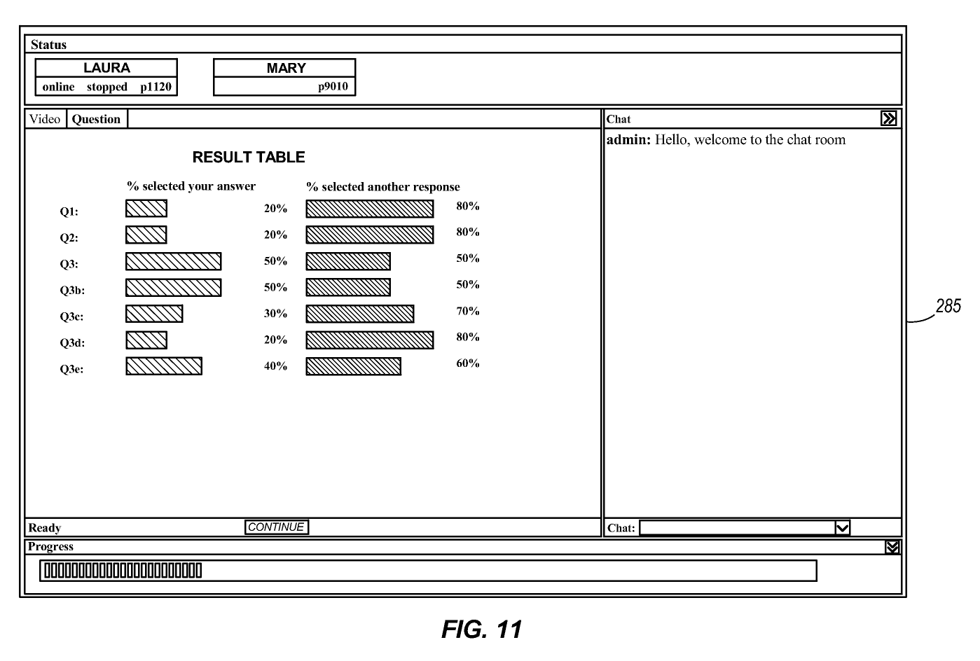

Referring again to the introductory skill assessment, FIG. 9 shows a web page 275 with the content pane 185 having information, i.e., a definition, prior to a question of the assessment. FIG. 10 shows a web page 280 that provides a question for the user taking the assessment. FIG. 11 is a web page 285 having a result table of the introductory skill assessment (block 290; FIG. 3). For other types of exercises, the results may look different.

The group may then proceed to a video segment portion (block 295). In this portion, the user is presented with, for example, a pre-recorded video scenario. The scenario can focus on the subject matter of the current case study. The video can provide plots and characters that are developed and acted out. The video may also include narrative segments that connect the elements of the case or video lectures to other relevant topics or other videos deemed necessary for understanding the case or making a decision.

A variety of inputs are used by the system 105 to determine which video segment a group may see. In one implementation, the system 105 is loaded with a curriculum and a tree data structure of possible scenarios the participants may encounter. The tree data structure can be similar to a root and branch system, where a scenario may present a question (block 300) with two or more choices (block 305). The next video and linked decision questions (blocks 310) are chosen based on, in one implementation, the decision reached by the majority of the group. With each decision made by the group, the system will progress to another branch in the tree data structure, with each branch presenting a different scenario and choices for the group of participants.

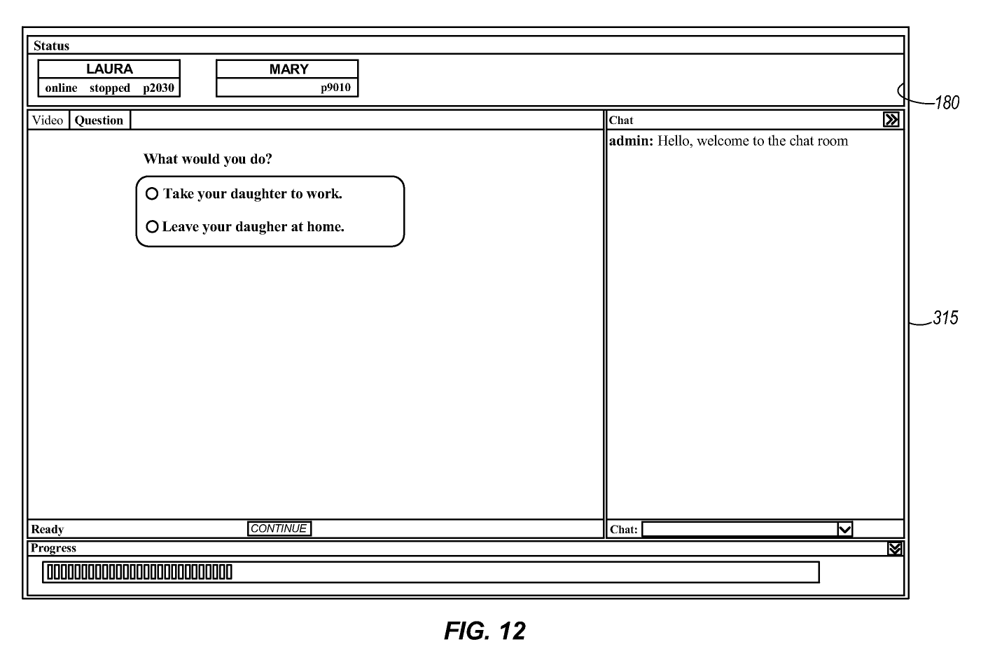

FIG. 12 shows an example of a decision point. For this web page 315, the participants are asked to make a decision based upon their training and the previously presented video scenario. As can be seen in FIG. 12, the user is presented with a number of options. The user preferably makes her choice within a certain time limit. The number of options offered and the amount of time given to participants may vary depending upon the exercise. The status pane may let group members know if the other participants have chosen an option yet. The status pane can also alert the user as to whether other participants have completed each stage of the case so that participants know whether to proceed through each stage as a group.

The decision point may represent a portion of the web site where group participation is necessary, and thus, the user may be required to wait after choosing a decision until all the participants have made their choices or until a time has expired. Group members may not be required to all choose the same selection as the continuation of the case may depend merely on a majority decision of participants or the default selected by the computer system in the case of a tie.

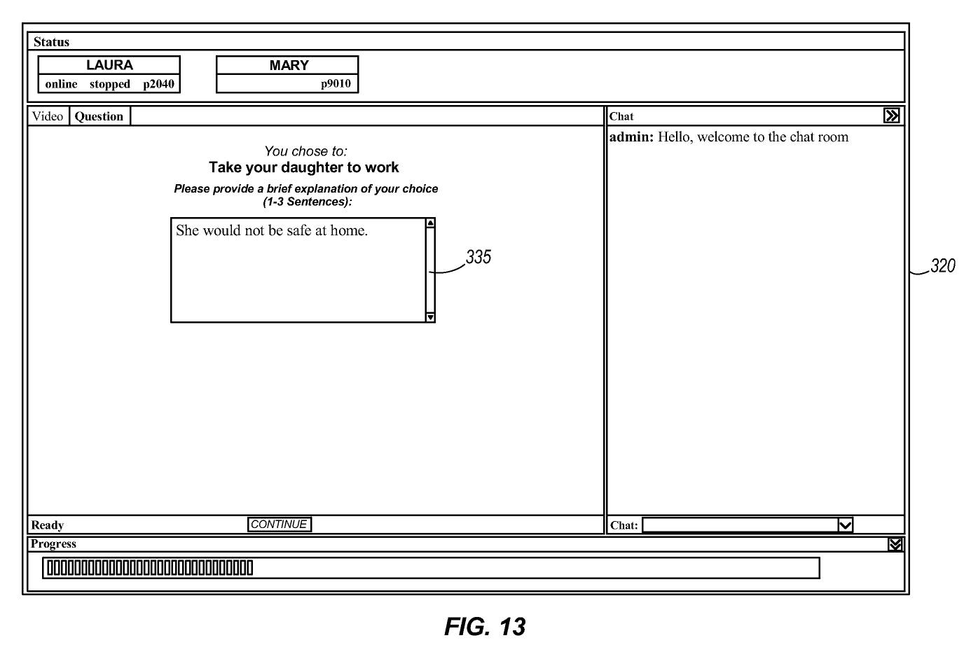

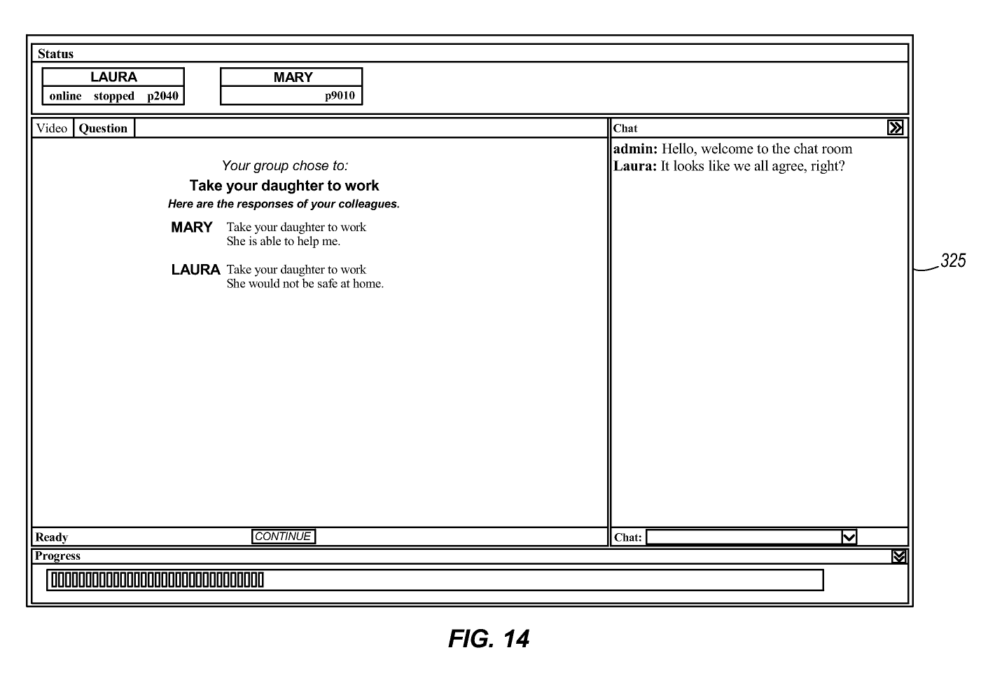

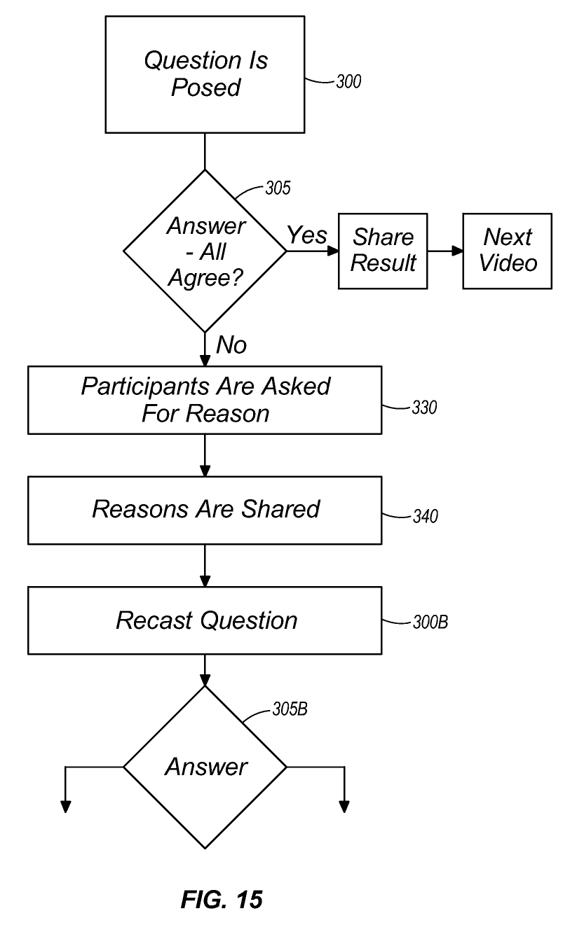

FIGS. 13 and 14 show web pages 320 and 325 having a group participation portion. When participants do not reach a unanimous decision, participants may be asked (box 330; FIG. 15) to explain the basis for their choices made at the decision point. This can be done in a response box 335 (FIG. 13). The explanations of all of the participants will be shared (box 340; FIG. 15) among all of the group members, as shown in web page 325 of FIG. 14. It is through the group participation portion that the students are challenged to experience alternative perspectives from their own, which can be a critical learning element in educational growth. Students are able to see that other participants may have a different approach to the present dilemma than did they in responding to the options presented.

It should be noted that in some implementations, real-time voice and/or video conferencing is available to participants. Real-time voice and/or video conferencing may allow participants to fully participate in group decisions and discussions. Additionally, real-time voice and/or video conferencing may aid participants when the system 105 is used to facilitate remote group decisions (e.g., corporate decisions). In some implementations, an online white-board application may be available to participants. The online white-board application may allow participants to discuss and work together through shared diagrams or to create shared diagrams and explanations using the system 105.

Each stage of the exercise may be driven by the choices that the group makes. When a group's decisions differ, participants are presented with both the decision that the group made as well as the responses that the participants have entered. In one implementation, participants may click on all other responses and review them before being permitted to continue. In this way, each participant may be exposed to the varying perspectives of other group members before proceeding. Depending on choices made by the leader in advance of the exercise, groups may then be permitted to enter into a chat room (i.e., chat pane 190; FIG. 4) for an online conversation. Again, depending on the option chosen by the leader in advance of the exercise, groups may then be presented with an option to return to the decision point (block 300B; FIG. 15) and recast their choice to see if a different group decision (block 305B) is reached, perhaps leading toward greater consensus subsequent to the group conversation.

It is also envisioned that the participants may enter their own suggested solutions to the problems and scenarios previously presented. Depending on options pre-chosen by the leader, these suggestions may be presented to the group of participants with a screen similar to the group decision portion shown in FIG. 14. Depending upon the training, participants may be able to vote upon suggested solutions. This suggestion portion may represent another part of the exercise where group participation is important, and thus, control bar 270 (FIG. 4) may be shaded and disabled until each member of the group has provided a suggestion.

As best represented in FIG. 3, a video may follow each question. Participants are presented with a video that may explain the implications of the group decision and what portion of the exercise is next. One example video type is a narrator video, that explains the implications of the group decision. Other videos may be shown in lieu of the narrator video. For example, a character video can include characters of the scenarios presented during earlier video segment portions act out or explain the consequences of the participants' decisions.

The pattern of scenario, choice, discussion, and follow-up continues until the group of participants finishes the curriculum (block 310) for that particular exercise. After the case study is over, participants may again be surveyed (block 345) with the same or different questions as those posed during the introductory assessment. In this way, the system 100 may be used not only to teach and train, but also to assess the effectiveness of participants and curricula (block 350).

Accordingly, the invention provides new and useful systems, methods, and tools for computer-implemented learning. Various features and advantages of the invention are set forth in the following claims.

What is claimed is:

1. A method of providing a computer-directed learning environment to a plurality of users, each user controlling a respective client device remote from a server, the method being performed by the server and comprising:
retaining instructions at the server, the instructions executable by the client devices to promote a computer-facilitated learning environment;
retaining content at the server, portions of the content utilized by the client devices to provide an exercise in the learning environment;
interactively communicating with a first client device, including
sending at least a first portion of the instructions to the first client device, thereby providing the computer-facilitated learning environment through the first client device;
sending a first portion of the content to the first client device, the first portion of the content having a first decision point in the exercise;
receiving a first response from the first client device, the first response responding to the first decision point and including a first decision from the first user;
sending a second portion of the content to the first client device, the second portion of the content being responsive to the first decision; and
sending and receiving a first message and a second message, respectively, with the first client device after the sending the first portion of the content and before the sending the second portion of the content.

2. The method of claim 1, and further comprising
interactively communicating with a second client device, including
sending at least a second portion of the instructions to the second client device, thereby providing the computer-facilitated learning environment through the second client device;
sending a third portion of the content to the second client device, the third portion of the content having a second decision point in the exercise;
receiving a second response from the second client device, the second response responding to the second decision point and including a second decision from the second user;
sending a fourth portion of the content to the second client device, the fourth portion of the content being responsive to the second decision.

3. The method of claim 1, and further comprising
interactively communicating with a second client device, including
sending at least a second portion of the instructions to the second client device, thereby providing the computer-facilitated learning environment through the second client device;
sending the first portion of the content to the second client device;
receiving a second response from the second client device, the second response responding to the first decision point and including a second decision from the second user;
sending the second portion of the content to the second client device, the second portion of the content being further responsive to the second decision; and
sending and receiving the second message and the first message, respectively, with the second client device after the sending the first portion of the content and before the sending the second portion of the content, thereby allowing the first user and the second user to communicate with each other.

4. The method of claim 3, wherein the at least first portion of the instructions and the at least second portion of the instructions include identical portions.

5. The method of claim 1, wherein the at least first portion of the instructions includes a web page having a plurality of panes.

6. The method of claim 5, wherein the plurality of panes includes a content pane, a status pane, and a chat pane.

7. The method of claim 6, wherein the content pane includes a plurality of tabs that further define the content pane.

8. The method of claim 1, wherein the second portion of the content includes a video file.

9. A method of providing a computer-directed learning environment to a plurality of users, each user controlling a respective client device remote from a server, the method being performed by the server and comprising:
retaining instructions at the server, the instructions executable by the client devices to promote a computer-facilitated learning environment;
retaining content at the server, portions of the content utilized by the client devices to provide an exercise in the learning environment
interactively communicating with the client devices, including
sending portions of the instructions to the client devices, thereby providing the computer-facilitated learning environment through the client devices;
sending a first portion of the content to the client devices, the first portion of the content having a first decision point in the exercise;
receiving responses from the client devices, the responses responding to the first decision point and including respective decisions from the users;
sending a second portion of the second content to the client devices, the second portion of the content being responsive to the decisions for the first decision point.

10. The method of claim 9, wherein the interactively communicating with the client devices further includes
sending a third portion of the content to the client devices, the third portion of the content having a second decision point in the exercise, the second decision point having a relation to the second portion of the content;
receiving second responses from the client devices, the second responses responding to the second decision point and including respective second decisions from the users; and
sending a fourth portion of the content to the client devices, the fourth portion being responsive to the second decisions for the second decision point.

11. The method of claim 10, wherein the second portion of the content includes a first video file and the fourth portion of the content includes a second video file.

12. The method of claim 9, wherein the exercise includes an education-related lesson.

13. The method of claim 9, wherein the exercise includes a group-related decision making exercise.

14. The method of claim 9, wherein the at least first portion of the first instructions includes a web page having a plurality of panes.

15. The method of claim 14, wherein the plurality of panes includes a content pane, a status pane, and a chat pane.

16. The method of claim 9, wherein interactively communicating with the client devices further includes sending the responses to the client devices.

17. The method of claim 9, wherein interactively communicating with the client devices further includes supporting interactive communication among the client devices after the sending the first portion of the content and before the sending the second portion of the content.

18. A method of receiving computer-directed content at a user-controlled client device from a server, the method being performed by the user-controlled client device and comprising:
receiving instructions from the server, the instructions constructing a portion of a computer-facilitated learning environment;
receiving first content from the server, the first content including a first decision point of an exercise;
sending a first response to the server, the first response responding to the first decision point and including a first decision from a user;
receiving second content from the server, the second content being responsive to the first decision; and
sending and receiving a first message and a second message, respectively, with the server after the sending the first portion of the content and before the sending the second portion of the content.

19. The method of claim 18, wherein the second content is based on the first decision and on decisions from other users conducting the exercise.

20. The method of claim 18, wherein the second message is from another user-controlled client, thereby allowing the users to communicate with each other.

21. The method of claim 18, further comprising
receiving third content from the server, the third content including a second decision point of the exercise;
sending a second response to the server, the second response responding to the second decision point and including a second decision from the user; and
receiving fourth content from the server, the fourth content being responsive to the second decision.

22. The method of claim 21, wherein the second decision point has a relation to the second content.

23. The method of claim 18, wherein the user-controlled client device includes at least one of a personal computer, a personal data assistant, a blackberry device, and a cellular phone.

24. The method of claim 18, wherein the constructing a portion of the computer-facilitated learning environment comprises displaying a web page having a plurality of panes.

25. The method of claim 24, wherein the plurality of panes includes a content pane.

26. The method of claim 25, wherein the plurality of panes further includes a status pane, and a chat pane.

27. The method of claim 25, wherein the content pane includes a plurality of tabs that further define the content pane.

28. A system for providing remote, real-time, computer-facilitated instruction and interaction to a plurality of users, the system comprising:
a system for shaping and directing a learning environment, the shaping/directing system comprising a server application to provide content of an exercise based on decisions from the users, the shaping/directing system further comprising a database to maintain the content; and
a plurality of user-controlled client devices connected to the shaping/directing system, for interfacing the learning environment to the users, and to send the responses to the shaping/directing system, each client device comprising an output device to communicate portions of the content to a respective user, the portions including decision points in the exercise, each client device further comprising an input device to receive decisions from the respective user replying to the decision points.

29. The system of claim 28, wherein each user-controlled client device includes at least one of a personal computer, a personal data assistant, a blackberry device, and a cellular phone.

30. The system of claim 28, wherein the server application includes a web server, a file server, a video server, and a chat server.

31. The system of claim 28, wherein the database includes video files, information files, and question files.

32. The system of claim 31, wherein the content of the exercise includes a final survey, and wherein the shaping/directing system creates a report for the exercise based on the final survey.

33. The system of claim 31, wherein the content of the exercise includes an initial survey and a final survey identical to the initial survey, and wherein the shaping/directing system creates a final report based on user responses to the initial and final survey.

34. The system of claim 28, wherein the server application includes a web server, and wherein the output device communicates the portions of the content to the respective user in a web page having a plurality of panes.

35. The system of claim 28, wherein the plurality of panes includes a content pane.

36. The system of claim 35, wherein the plurality of panes further includes a status pane, and a chat pane.

37. The system of claim 35, wherein the content pane includes a plurality of tabs that further define the content pane.

38. The system of claim 28, wherein the system further comprises a server application to promote communication among the plurality of users during the exercise.
